(19) United States
(12) Patent Application Publication
(10) Pub. No.: US 2019/0333428 A1
(43) Pub. Date: Oct. 31, 2019

(54) RENEWABLE FROZEN MATERIAL DISPLAY

(71) Applicant: ERA DIGITAL MEDIA CO., LTD., Taipei City (TW)

(72) Inventor: FU-SHENG CHIU, TAIPEI CITY (TW)

(21) Appl. No.: 15/963,368

(22) Filed: Apr. 26, 2018

(51) Int. Cl. G09G 3/00; H04W 4/02

(52) U.S. Cl. CPC G09G 3/002; H04W 4/025; G09G 3/003

(57) ABSTRACT

A renewable frozen material display for displaying 2-dimensional images on or in the frozen material and 3-dimensional images above the frozen material. The frozen material is easily renewed by reflowing and freezing the liquid material to create a new display. A plurality of light sources emit light into or onto the frozen material to form the images. A plurality of sensors detect location or position of an object or participant which affects or determines aspects of the images or which image is displayed. User devices via a server interact with the renewable frozen material display and affect content of the 2-dimensional and 3-dimensional images and location of the 2-dimensional and 3-dimensional images to provide a group interacting activity environment.

### BACKGROUND OF THE INVENTION

### Field of the Invention

The present invention relates to presentation displays and screens. More specifically, the present invention discloses a renewable frozen material or ice display for providing 2-dimensional and 3-dimensional images in an interactive environment.

### Description of the Prior Art

Conventional presentation displays are electronic screens such as television monitors that receive digital data and convert it into an image.

Unfortunately, the conventional screen requires positioning in an upright position in the eyesight of a spectator. However, there are many situations where the installation of the screen would be better positioned below the spectator.

Disadvantageously, if the conventional screen is positioned below the spectator the surface of the screen is damaged by the spectator walking across the screen. As a result the screen is easily scratched or broken and the image is degraded.

Therefore, there is need for an improved presentation display for presenting 2-dimensional images and 3-dimensional images that can be easily renewed to optimal display and projecting image properties.

### SUMMARY OF THE INVENTION

To achieve these and other advantages and in order to overcome the disadvantages of the conventional method in accordance with the purpose of the invention as embodied and broadly described herein, the present invention provides a display surface comprising a frozen material such as ice to display 2-dimensional images and 3-dimensional images in still photo or video format.

A frozen surface such as a substrate of frozen water (ice) is provided. For example, a surface of an ice skating rink forms the display screen of a renewable frozen material display.

A plurality of light sources emit light into the sides of the frozen material. The emitted lights interact to form 2-dimensional images in the frozen material or are reflected and emitted from the frozen material to form a 3-dimensional image above the surface of the frozen material.

The surface of the frozen material or the frozen material is easily renewed by reflowing material and refreezing the material to create a new frozen material display.

Sensors detect a participants position or location on the frozen material to cause interactivity between image content and user interaction. For example, participants can participate in a game displayed on or above the frozen material and their actions/movements will determine which images are displayed.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification.

The drawings illustrate embodiments of the invention and, together with the description, serve to explain the principles of the invention. In the drawings:

FIG. 1 is a drawing illustrating a renewable frozen material display providing 2-dimensional and 3-dimensional images according to an embodiment of the present invention;

FIG. 2 is a drawing illustrating a renewable frozen material display with a plurality of light sources according to an embodiment of the present invention;

FIG. 3 is a drawing illustrating a renewable frozen material display with a plurality of light sources according to an embodiment of the present invention;

FIG. 4 is a drawing illustrating a renewable frozen material display with a diffusion surface according to an embodiment of the present invention;

FIG. 5 is a drawing illustrating a renewable frozen material display with a plurality of intersecting emitted light according to an embodiment of the present invention;

FIG. 6 is a drawing illustrating a renewable frozen material display with a linear light guide according to an embodiment of the present invention;

FIG. 7 is a drawing illustrating a renewable frozen material display with a plurality of sensors according to an embodiment of the present invention; and

FIG. 8 is a drawing illustrating a renewable frozen material display with a plurality of light sources according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

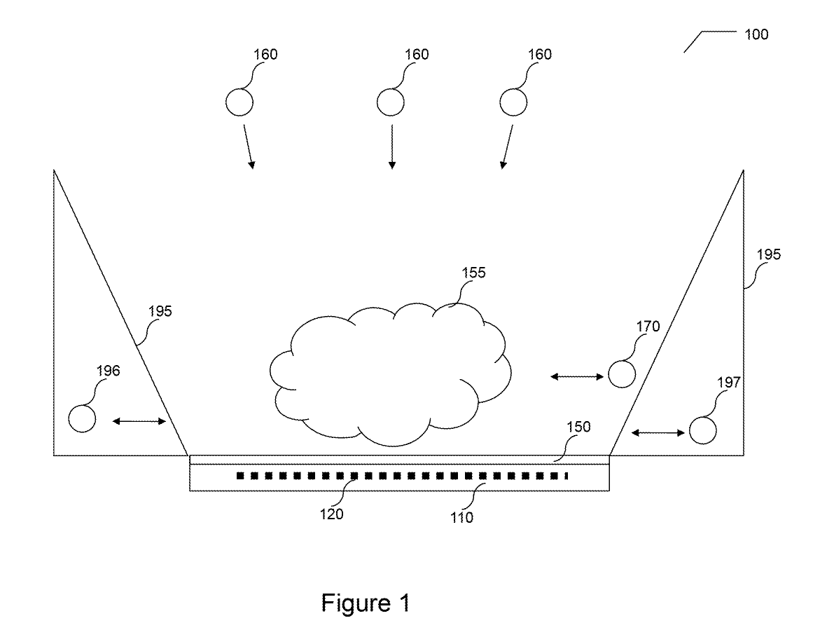

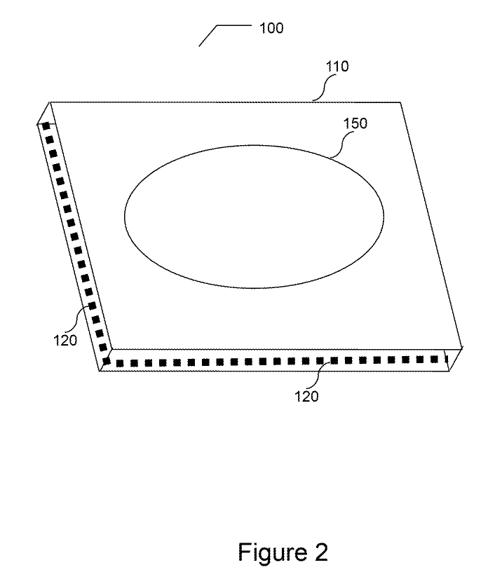

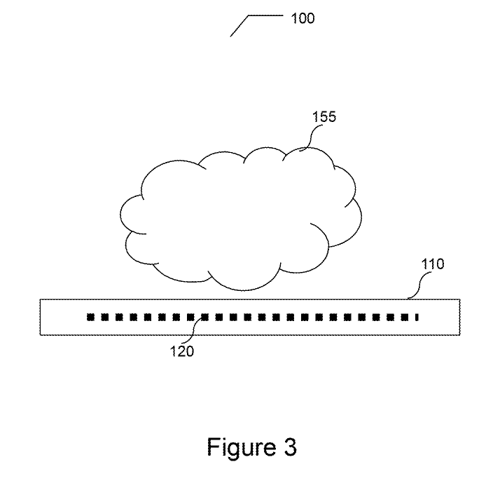

Refer to FIGS. 1-3, which are drawings illustrating a renewable frozen material display providing 2-dimensional and 3-dimensional images according to embodiments of the present invention.

The renewable frozen material display 100 comprises a substrate of frozen material 110. For example, the frozen material 110 comprises frozen water or ice.

A plurality of light sources 120 are provided on at least one side of the frozen material 110. The plurality of light sources 120 comprises light emitting diodes (LEDs) or laser light sources capable of emitting colored lights.

When activated the plurality of light sources 120 emit light into sides of the frozen material 110. The emitted light combines or interacts to form a 2-dimensional image 150 in or on the frozen material 110. In embodiments of the present invention a 3-dimensional image 155 is formed on top of or above the frozen material 110.

Additionally, in embodiments of the present invention at least one external light source 160 is provided above or around the frozen material. For example, the external light source 160 comprises a spotlight, a video projector, a laser light source, or a holographic image projector. The external light source 160 collaborates with the plurality of light sources 120 to create the 2-dimensional image 150 and the 3-dimensional image 155. Seating 195 or spectator viewing area is provided 195 around the frozen material 110.

An advantage of the present invention, as needed the raw material of the frozen material 110 is reflown across the base and frozen to create a renewed frozen material display 100. For example, is the surface of the frozen material 110 becomes scratched or distorted, the surface of the frozen material display 100 is remade as a new surface in order to create sharper or better 2-dimensional images 150 and 3-dimensional images 155.

In an embodiment of the present invention the renewable frozen material display 100 comprises a plurality of sensors 170 positioned around, above, in, and/or below the frozen material 110.

In an embodiment of the present invention a server 197 cooperates with the sensors 170 to obtain and analyze sensor data, with the light sources 120,160 to control light and image data, and spectator/user devices 196 to receive user data and send control options to the spectator/user devices 196.

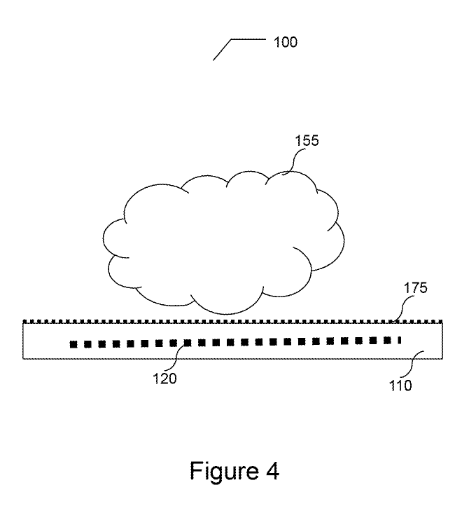

Refer to FIG. 4, which is a drawing illustrating a renewable frozen material display with a diffusion surface according to an embodiment of the present invention.

In an embodiment of the present invention the frozen material 110 of the frozen material display 100 further comprises a diffusion surface 175.

The diffusion surface 175 comprises hashed lines, criss-cross lines, pitted indentations, etc and are created in the top surface of the frozen material 110. The diffusion surface 175 affect the emitted light from the plurality of light sources 120 and affect the resultant 2-dimensional image and 3-dimensional image 155. For example, the diffusion surface 175 softens the contrast or edges of the images.

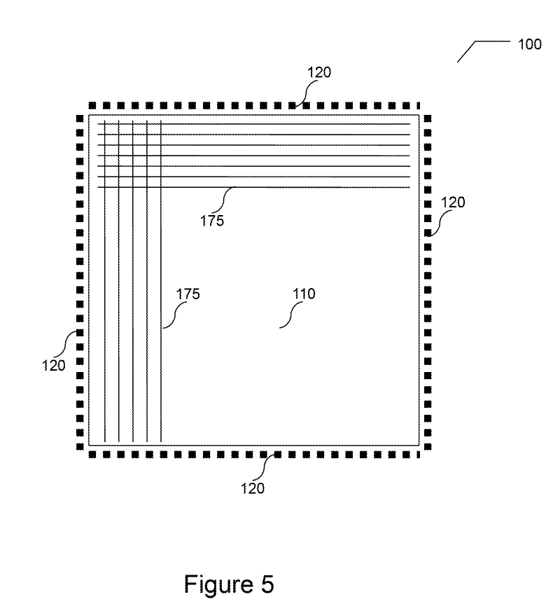

Refer to FIG. 5, which is a drawing illustrating a renewable frozen material display with a plurality of intersecting emitted light according to an embodiment of the present invention.

In the renewable frozen material display 100, the plurality of light sources 120 project emitted light 175 into the frozen material 110.

The emitted light 175 passes through the frozen material 110 and intersect. The intensity and color of the intersecting lights are variable to determine the images or aspects of the images.

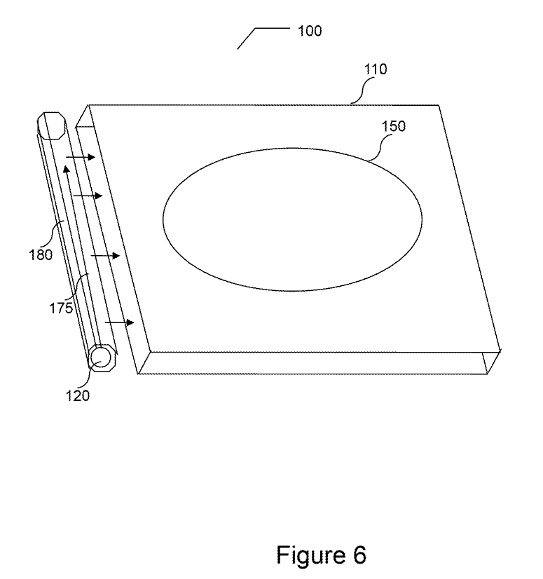

Refer to FIG. 6, which is a drawing illustrating a renewable frozen material display with a linear light guide according to an embodiment of the present invention.

In an embodiment of the present invention the frozen material display 100 comprises a linear light source 120. The linear light source 120 comprises, for example, a light emitting diode, a plurality of light emitting diodes, or a light emitting diode module. The linear light source 120 emits light 175 into an end of a transparent or translucent light guide 180. The emitted light 175 travels through the light guide and is reflected into the frozen material 110.

The light guide 180 comprises an elongated polygonal material. A reflector or reflective surface is provided on at least one side of the polygonal material to assist in increasing the reflectivity of emitted light thereby improving the 2-dimensional image 150 and 3-dimensional image.

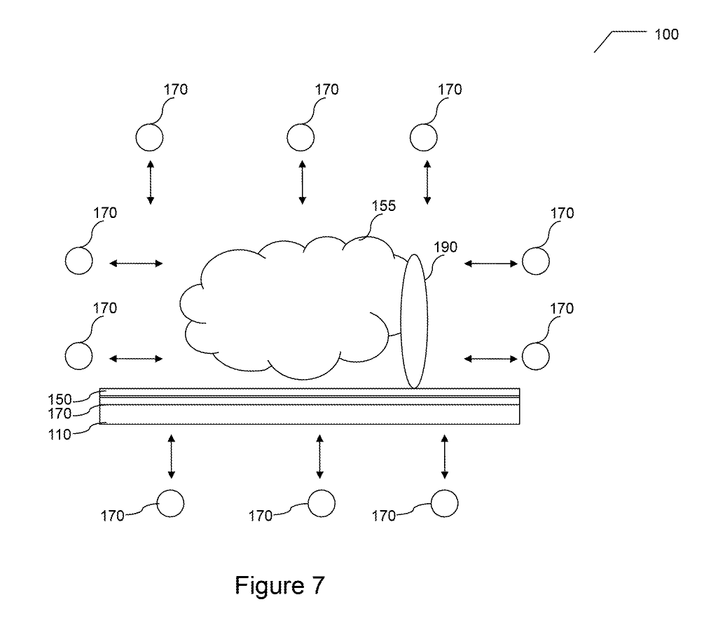

Refer to FIG. 7, which is a drawing illustrating a renewable frozen material display with a plurality of sensors according to an embodiment of the present invention.

In an embodiment of the present invention the renewable frozen material display 100 comprises a plurality of sensors 170 positioned around, above, in, and/or below the frozen material 110.

The sensors 170 comprise a motion detector, a heat sensor, a pressure sensor, an infrared tag/ID reader, a bluetooth transceiver, an ultrasonic transceiver, or a wireless transceiver.

The sensors 170 detect the position or location of an object or participant 190 on the frozen material 110. The sensors 170 allow for the participant 190 or object to affect the 2-dimensional image 150 and 3-dimensional image 155 or determine which 2-dimensional image 150 and 3-dimensional image 155 is displayed or determine game play.

In this way, the participant 190 can interact with the 2-dimensional image 150 and 3-dimensional image 155 in order to interactively determine the progress or outcome of a media presentation of the frozen material display 100.

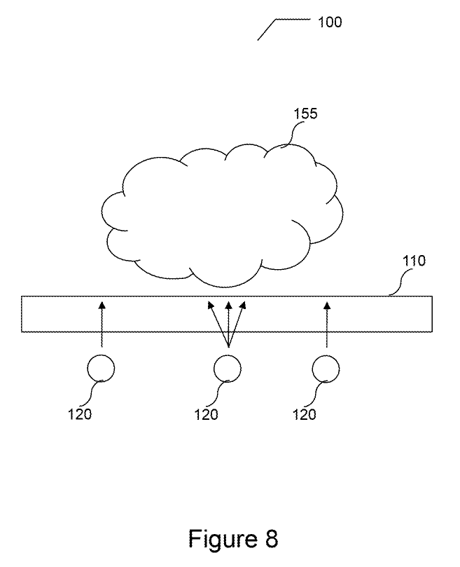

Refer to FIG. 8, which is a drawing illustrating a renewable frozen material display with a plurality of light sources according to an embodiment of the present invention.

In an embodiment of the present invention a plurality of light sources 120 are provide under the frozen material 110. The emitted light cooperates to form the 2-dimensional image 150 and 3-dimensional image 155 of the frozen material display 100.

Refer to FIGS. 1 and 7.

The present invention comprises a server 197 that cooperates and interacts with the sensors 170 to obtain and analyze sensor data, with the light sources 120,160 to control light and image data, and spectator/user devices 196 to receive user data and send control options to the user devices 196.

Users utilize user devices 196 to interact with the renewable frozen material display 100. For example, users can determine what image or object is displayed in a 2-dimensional and 3-dimensional image or can determine the image or objects position or location.

For example, a participant 190 moves across the substrate and is interacting with the 2-dimensional and 3-dimensional image via the sensors 170, the user via the user device 196 sends commands or selects options that control the 2-dimensional and 3-dimensional image or the position of the 2-dimensional and 3-dimensional image.

The server 197 receives the data from the user device 196 and revises or alters the 2-dimensional and 3-dimensional image or the position of the 2-dimensional and 3-dimensional image.

In this way, a user or a plurality of users via user devices 196 can interact with the participant or participants 190 and the renewable frozen material display 100 to provide a group interaction activity.

In an embodiment of the present invention the user device 196 is a mobile phone.

The server comprises a volatile memory, a non-volatile memory, a central processing unit, and a wireless transceiver.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A renewable frozen material display for providing 2-dimensional and 3-dimensional images comprising:
a substrate of frozen liquid material; and
a plurality of light source emitting light into the substrate of frozen liquid material to display the 2-dimensional and 3-dimensional images.

2. The renewable frozen material display for providing 2-dimensional and 3-dimensional images of claim 1, further comprising:
a plurality of sensors for detecting position on the substrate.

3. The renewable frozen material display for providing 2-dimensional and 3-dimensional images of claim 2, the plurality of sensors comprising:
motion detectors, heat sensors, pressure sensors, infrared identification readers, bluetooth transceivers, ultrasonic transceivers, wireless transceivers or a combination of motion detectors, heat sensors, pressure sensors, infrared identification readers, bluetooth transceivers, ultrasonic transceivers, wireless transceivers.

4. The renewable frozen material display for providing 2-dimensional and 3-dimensional images of claim 1, the frozen liquid material comprising water.

5. The renewable frozen material display for providing 2-dimensional and 3-dimensional images of claim 1, further comprising:
a plurality of external light sources positioned above, below, and/or around the frozen liquid material to cooperate in forming the 2-dimensional and 3-dimensional images.

6. The renewable frozen material display for providing 2-dimensional and 3-dimensional images of claim 5, the plurality of external light sources comprising spot lights, video projectors, holographic imaging projectors, laser lights, or a combination of spot lights, video projectors, holographic imaging projectors, and laser lights.

7. The renewable frozen material display for providing 2-dimensional and 3-dimensional images of claim 1, further comprising:
a plurality of sensors for detecting position of a participant's location on the substrate, the participant's location affecting the 2-dimensional and 3-dimensional images.

8. The renewable frozen material display for providing 2-dimensional and 3-dimensional images of claim 1, further comprising:
a plurality of sensors for detecting position of a participant's location on the substrate, the participant's location determining which 2-dimensional and 3-dimensional images are displayed.

9. The renewable frozen material display for providing 2-dimensional and 3-dimensional images of claim 1, the plurality of light sources comprising:
light emitting diodes (LEDs) or laser light sources capable of emitting colored light.

10. The renewable frozen material display for providing 2-dimensional and 3-dimensional images of claim 1, further comprising:
a diffusion surface on the frozen liquid material for diffusing light emitted by the plurality of light sources.

11. A renewable frozen material display for providing 2-dimensional and 3-dimensional images comprising:
a substrate of frozen liquid material;
a plurality of light source emitting light into the substrate of frozen liquid material to display the 2-dimensional and 3-dimensional images; and
a plurality of sensors for detecting position on the substrate.

12. The renewable frozen material display for providing 2-dimensional and 3-dimensional images of claim 11, the plurality of sensors comprising:
motion detectors, heat sensors, pressure sensors, infrared identification readers, bluetooth transceivers, ultrasonic transceivers, wireless transceivers or a combination of motion detectors, heat sensors, pressure sensors, infrared identification readers, bluetooth transceivers, ultrasonic transceivers, wireless transceivers.

13. The renewable frozen material display for providing 2-dimensional and 3-dimensional images of claim 11, the frozen liquid material comprising water.

14. The renewable frozen material display for providing 2-dimensional and 3-dimensional images of claim 11, further comprising:
a plurality of external light sources positioned above, below, and/or around the frozen liquid material to cooperate in forming the 2-dimensional and 3-dimensional images.

15. The renewable frozen material display for providing 2-dimensional and 3-dimensional images of claim 14, the plurality of external light sources comprising spot lights, video projectors, holographic imaging projectors, laser lights, or a combination of spot lights, video projectors, holographic imaging projectors, and laser lights.

16. The renewable frozen material display for providing 2-dimensional and 3-dimensional images of claim 11, further comprising:
the plurality of sensors for detecting position of a participant's location on the substrate, the participant's location affecting the 2-dimensional and 3-dimensional images.

17. The renewable frozen material display for providing 2-dimensional and 3-dimensional images of claim 11, further comprising:
the plurality of sensors for detecting position of a participant's location on the substrate, the participant's location determining which 2-dimensional and 3-dimensional images are displayed.

18. The renewable frozen material display for providing 2-dimensional and 3-dimensional images of claim 11, the plurality of light sources comprising:
light emitting diodes (LEDs) or laser light sources capable of emitting colored light.

19. The renewable frozen material display for providing 2-dimensional and 3-dimensional images of claim 11, further comprising:
a diffusion surface on the frozen liquid material for diffusing light emitted by the plurality of light sources.

20. A renewable frozen material display for providing 2-dimensional and 3-dimensional images comprising:
a substrate of frozen liquid material;
a plurality of light sources emitting light into or onto the substrate of frozen liquid material to display the 2-dimensional and 3-dimensional images;
a plurality of sensors for detecting position of a participant's location on the substrate, the participant's location affecting content of the 2-dimensional and 3-dimensional images and location of the 2-dimensional and 3-dimensional images;
at least one user device to interact with the renewable frozen material display and affecting content of the 2-dimensional and 3-dimensional images and location of the 2-dimensional and 3-dimensional images;
a server for interacting with the sensors to obtain and analyze sensor data, with the light sources to control light and image data, and with the at least one user device to receive user data and send control options to the user devices, the server comprising a volatile memory, a non-volatile memory, a central processing unit, and a wireless transceiver, the wireless transceiver communicating with the plurality of light sources, the plurality of sensors, and the at least one user device.
